(19) United States
(12) Patent Application Publication
(10) Pub. No.: US 2012/0308331 A1
(43) Pub. Date: Dec. 6, 2012

(54) FIXING MEMBER

(76) Inventors: Gou MINAMI, Ichinomiya-shi (JP); Masaya Minamikawa, Nagoya-shi (JP)

(21) Appl. No.: 13/234,970

(22) Filed: Sep. 16, 2011

(30) Foreign Application Priority Data
Jun. 2, 2011 (JP) JP2011-003097U

(51) Int. Cl. F16B 25/10

(52) U.S. Cl. 411/387.2

(57) ABSTRACT

A fixing member is provided for fixing a ceramic exterior building material to a lightweight thin steel sheet. The fixing member includes a screw portion and a head portion at an upper end of the screw portion. A threaded portion in which a screw thread is formed is provided at a lower end of the head portion, a cutting portion in which a reamer is formed is provided at a lower end of the threaded portion, a pilot portion that has no screw thread is provided at a lower end of the cutting portion, and a tapered drill portion is provided at a lower end of the pilot portion. The thickness “g” of the ceramic exterior building material and the total of the length “e” of the pilot portion that has no screw thread and the length “f” of the tapered drill portion satisfy the relationship g<e+f.

### BACKGROUND OF THE INVENTION

1. Field of the Invention

The present invention relates to a fixing member for fixing a ceramic exterior building material to a lightweight thin steel sheet.

2. Description of Related Art

Conventionally, installation of a ceramic exterior building material of 14 mm or less has been performed by attaching timber furring strips having a thickness of 15 to 18 mm, a width of 45 mm, and a length of 3000 mm to an exterior side of a timber stud frame at intervals of 455 mm to construct the base, and nailing the ceramic exterior building material to the furring by driving stainless steel nails of 2.3 mm diameter by 43 mm long at intervals of 150 mm in the surface of the ceramic exterior building material. In the case of installation on a steel-framed structure conforming to the JIS standards, 33 mm thick by 45 mm wide by 3000 mm long timber furring strips were fixed to the exterior side of a lipped-channel-shaped steel sheet having a thickness of 1.6 to 2.3 mm, a horizontal width of 45 to 75 mm, and a vertical width of 50 to 100 mm of the steel frame with screws, and then a ceramic exterior building material of 14 mm or less was nailed to the exterior side of the timber furring.

There were cases where directly fastening a ceramic exterior building material to a steel-framed structure formed of a lipped-channel-shaped steel sheet with screws caused cracking or fracture around the screws due to motion or vibration of the building because the holding power of screws is about three times greater than the holding power of nails, and the holding power of screws in a steel frame is stronger than the strength of a ceramic exterior building material. For this reason, it is not desirable to directly fasten a ceramic exterior building material to a steel-framed structure with screws.

However, in cases where an external insulation method, a steel-framed structure construction method, or the like is performed, omission of, or simplification of installation of, timber furring strips and weight reduction are strongly demanded, and furthermore, there is a strong demand for the use of a 1.2 mm lightweight thin steel sheet. In the case where a lightweight thin steel sheet was mounted through a gap of an external insulation material and exposed to the surface of the insulation material, and a ceramic exterior building material was fastened to the lightweight thin steel sheet with screws, there were problems that since an ordinary reamer screw assumes a 2.3 mm steel sheet, the reamer was not stripped when in contact with a 1.2 mm lightweight thin steel sheet, a clearance hole was also formed in the lightweight thin steel sheet serving as the base material, and the ceramic exterior building material could not be attached. Moreover, in the case where a drill screw without a reamer was employed, motion or vibration of the building caused a defect such as cracking or fracture around the screw due to the strong holding power of the screw.

As a remedy for conventional problems such as those described above, for example, JP 2009-180040A discloses that in order to fix a slate, which is a thin member to be attached and is used as a roofing material or the like, to a base material, the slate is pierced with a cutting portion at a lower end of a connecting portion at a lower end of a head portion of a screw, and the screw is screwed into the base material. However, even though this invention may be effective in the case where the members to be attached about half overlap as in a roof portion and unevenness is required, in the case of walls, with regard to a ceramic exterior building material whose thickness will decrease further and strength will decrease if cut into a thinner shape, it is not possible to solve the aforementioned problems. Moreover, since the screw portion comes into contact with the base material first during installation, the ceramic exterior building material floats, which makes it impossible to perform installation and causes a defect such as cracking or fracture.

Moreover, with regard to a drill screw with a reamer such as disclosed in JP 7-30772B, a drill portion is larger than a screw shank portion. Therefore, in the case of a combination of a wood and a metal sheet, assuming that a 2.3 mm steel sheet conforming to the JIS standards is used, a reamer portion will be stripped, but if a 1.2 mm lightweight thin steel sheet is used, the reamer portion will not be stripped, and a clearance hole will be formed, making it impossible to attach the ceramic exterior building material and causing a defect such as cracking or fracture.

### SUMMARY OF THE INVENTION

The present invention has been made in view of the circumstances of conventional technologies such as described above, and it is an object thereof to provide a fixing member that allows for even a ceramic exterior building material to be fastened with screws and prevents the occurrence of cracking or fracture due to motion or vibration of a building even when a lightweight thin steel sheet is used.

In order to attain the above-described object, the present invention provides a fixing member for fixing a ceramic exterior building material to a lightweight thin steel sheet, the fixing member including a screw portion and a head portion at an upper end of the screw portion, wherein a threaded portion in which a screw thread is formed is provided at a lower end of the head portion, a cutting portion in which a reamer is formed is provided at a lower end of the threaded portion, a pilot portion that has no screw thread is provided at a lower end of the cutting portion, and a tapered drill portion is provided at a lower end of the pilot portion; and a thickness “g” of the ceramic exterior building material and a total of a length “e” of the pilot portion that has no screw thread and a length “f” of the tapered drill portion satisfy a relationship g<e+f. Furthermore, it is preferable that an outer diameter of the tapered drill portion is smaller than an outer diameter of the threaded portion in which the screw thread is formed. Moreover, it is more preferable that an outer diameter “a” of the head portion, an outer diameter “b” of the cutting portion, an outer diameter “c” of the threaded portion with the screw thread, and an outer diameter “d” of the tapered drill portion satisfy a relationship a>b>c>d.

According to the fixing member of the present invention, it is possible to provide a fixing member that passes through a ceramic exterior building material and fixedly attaches a screw thread to a lightweight thin steel sheet without forming a clearance hole in the lightweight thin steel sheet, and prevents the ceramic exterior building material from cracking due to motion or vibration of a building. Accordingly, timber furring strips are omitted and are not used, and simplification of installation of the lightweight thin steel sheet, weight reduction, and cost-effectiveness can be achieved.

### BRIEF DESCRIPTION OF THE DRAWINGS

FIG. 1 is a diagram showing a fixing member according to an embodiment of the present invention.

FIG. 2 is a cross-sectional view at the time when the fixing member has come into contact with a lightweight thin steel sheet according to the embodiment of the present invention.

FIG. 3 is a cross-sectional view at the time when a tapered drill portion of the fixing member is piercing the lightweight thin steel sheet according to the embodiment of the present invention.

FIG. 4 is an enlarged cross-sectional view at the time when the fixing member has passed through the ceramic exterior building material and a head portion of the fixing member presses against the ceramic exterior building material according to the embodiment of the present invention.

FIG. 5 is a cross-sectional view of a metal sheet of a conventional steel-framed structure to which a drill screw equipped with a reamer was applied.

FIG. 6 is a cross-sectional view in which a screw thread is screwed in the metal sheet of the conventional steel-framed structure to which the drill screw equipped with the reamer was applied.

FIG. 7 is a cross-sectional view of a metal sheet showing a state in which the fixing member of the present invention was applied to the lightweight thin steel sheet.

FIG. 8 is a cross-sectional view showing a state in which a screw thread is screwed in the metal sheet after the fixing member of the present invention was applied to the lightweight thin steel sheet.

### DETAILED DESCRIPTION OF THE INVENTION

Hereinafter, the best mode for carrying out the present invention will be specifically described.

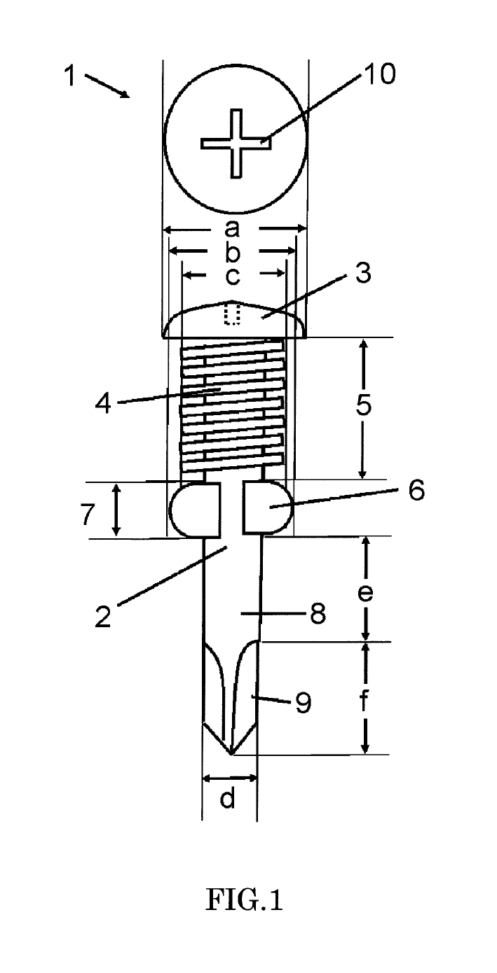

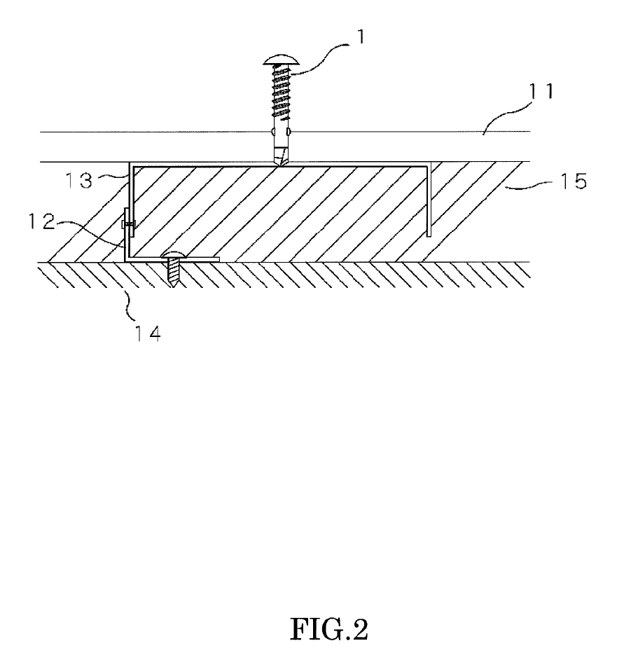

A fixing member 1 shown in FIG. 1 is used to fix a ceramic exterior building material 11 to a U-shaped steel sheet 13 as shown in FIG. 2. Although there is no particular limitation to the configuration of the ceramic exterior building material 11 and the U-shaped steel sheet 13 serving as a base, for example, the ceramic exterior building material 11 has a thickness of about 8 mm, and the U-shaped steel sheet 13 is a lightweight thin steel sheet having a thickness of about 1.2 mm.

Although the size of this ceramic exterior building material 11 is 8 mm thick by 600 mm by 2400 mm, common types of the ceramic exterior building material 11 have a thickness of about 5 mm, 6 mm, 7 mm, or 8 mm to 27 mm, a width of 455 mm to 1000 mm, and a length of about 1820 to 3030 mm. Examples of the material for the ceramic exterior building material 11 include a cement board (wood fiber reinforced board) in which wood fiber such as wood chip, wood pulp, wood fiber, or pulp is added, an extruded cement board, a pulp cement board, a calcium silicate board, a magnesium carbonate board, and a cement board. The ceramic exterior building material 11 of 14 mm or less is generally fastened with nails. In the case of the ceramic exterior building material 11 having a thickness of more than 14 mm, a rebate portion (not shown) is sandwiched in a fastener and fixed to the fastener with stainless steel nails in the case of a timber structure, or with drill screws in the case of a steel-framed structure. It is not desirable to apply screws to the surface of the ceramic exterior building material 11 because the holding power of the screws in a lightweight steel frame is strong.

A structural skeleton 14 as shown in FIG. 2 is constructed of reinforced concrete or brick. An L-shaped steel sheet 12 and a U-shaped steel sheet 13 are installed on an exterior side of this structural skeleton 14. The steel sheet is a lightweight thin steel sheet having a thickness of about 1.2 mm, a depth of 45 mm, a width of 60 mm, and an overall length of 3 m. Such a steel sheet is called “light gauge steel (LGS)”, which commonly has a thickness of about 0.8 to 1.6 mm and is made of sheet steel, and those having a thickness of 1.2 mm are most widely used. External insulation is a method in which an insulation material 15, such as glass wool, rock wool, or a material made of rigid polyurethane foam, is installed in a hollow portion of a combination of base members such as described above. In an ordinary steel-framed building, a lipped-channel-shaped steel sheet of about 2.3 to 3.2 mm for a lightweight steel frame conforming to the JIS is commonly used as a base member of the steel-framed structure. When compared with the lightweight thin steel sheet, the lightweight steel frame conforming to the JIS has a larger thickness and a higher strength, and is more expensive.

A fixing member 1 in FIG. 1 includes a screw portion 2 and a head portion 3. A part of the head portion 3 that is in contact with the screw portion 2 has a flat surface, and thus the screw pressure is uniformly applied to the ceramic exterior building material 11 when fastened. Furthermore, the head portion 3 has a fitting recess 10 that is formed in the curved surface of the disk-like shape of the head portion 3. The thickness of the head portion 3 can be set to any desired value as long as this portion has sufficient strength and the fitting recess 10 into which a tool such as a driver bit can be fitted. A recess having an appropriate shape, such as cross-shaped grooves or a linear slot, is formed as the fitting recess 10. Moreover, the fitting recess 10 can even reach the screw portion 2 through the head portion 3. This prevents the head portion 3 from being stripped when the fixing member 1 is screwed using the tool such as a driver bit. Although the head portion 3 in FIG. 1 has a round head shape, a flat head shape and a head shape with cutting ribs can also be used without problem, and a shape suitable for the shape and the thickness of the ceramic exterior building material 11 can be set.

A screw thread 4 of a threaded portion 5 may be a multiple thread having a plurality of helices or may be a large-pitch thread such as a coarse thread.

An outer diameter “b” of a cutting portion 7 in which a reamer 6 is formed is larger than an outer diameter “c” of the threaded portion 5 in which the screw thread 4 is formed. After a tapered drill portion 9 at a leading end of the fixing member 1 comes into contact with the surface of the ceramic exterior building material 11, a pilot portion 8 that is not provided with the screw thread 4 penetrates the exterior building material, then, the reamer 6 comes into contact with the exterior building material, and the cutting portion 7 rotates (see FIG. 2). At this time, the pilot portion 8 that is not provided with the screw thread 4 rotates. Since the reamer 6 has a thickness of 0.3 to 0.4 mm and the U-shaped steel sheet 13 is a lightweight thin steel sheet having a thickness of about 1.2 mm, once the reamer 6 comes into contact with the U-shaped steel sheet 13, the reamer 6 is stripped because its thickness is small. Thus, after the reamer 6 is stripped, the threaded portion 5 with the screw thread 4 is screwed into the 1.2 mm U-shaped steel sheet 13. Furthermore, since the outer diameter “b” of the cutting portion 7 with the reamer 6 is larger than the outer diameter “c” of the threaded portion 5 with the screw thread 4, a gap is formed between the ceramic exterior building material 11 and the threaded portion 5. This gap prevents excess force from being applied to the ceramic exterior building material 11 having a thickness of 8 mm, provides a clearance hole, and prevents the occurrence of cracking in the ceramic exterior building material 11 due to motion or vibration of a building. In addition, there is no friction, and thus heat is not generated.

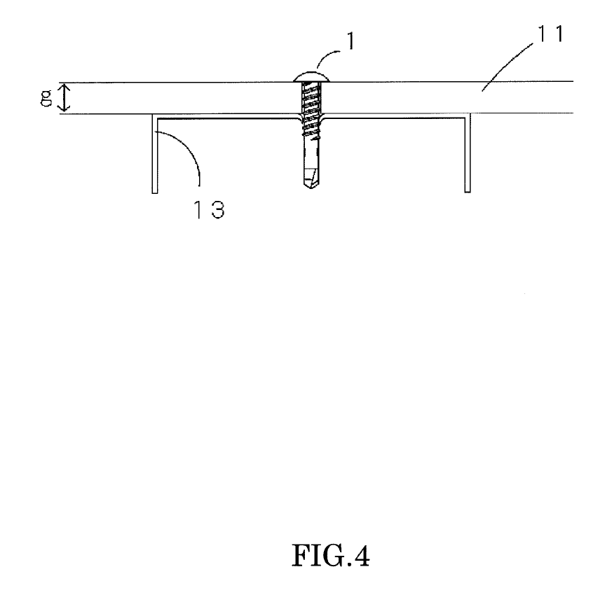

Usually, the reamer 6 is located in the drill portion at the leading end, and a configuration in which the threaded portion 5 with the screw thread 4 is located contiguously to the drill portion is common. However, according to the fixing member 1 of the present invention, the combined length of the tapered drill portion 9 and the pilot portion 8 connected to the drill portion 9 is 10 mm, so that these portions pierce through the thickness of the ceramic exterior building material 11 before the reamer 6 comes into contact with the surface of the U-shaped steel sheet 13 and is stripped. Therefore, due to this combined length of 10 mm, the threaded portion 5 is prevented from coming into contact with the ceramic exterior building material 11, so that the exterior building material does not float during installation and can be stably fastened. Moreover, since the reamer 6 has a disk-like shape and therefore makes contact more smoothly than an ordinary reamer having a trapezoidal shape or a rectangular shape, the reamer 6 is reliably stripped (see FIG. 4).

Moreover, the size of the outer diameter “a” of the head portion 3 is 9.4 mm, the size of the outer diameter “b” of the cutting portion 7 with the reamer 6 is 4.8 mm, and the size of the outer diameter “c” of the threaded portion 5 with the screw thread 4 is 4.3 to 4.6 mm. The size of the outer diameter “d” of the tapered drill portion 9 is 2.3 mm, and the tapered drill portion 9 is made into a shape that can easily penetrate the lightweight thin steel sheet. Thus, the relationship a>b>c>d is satisfied.

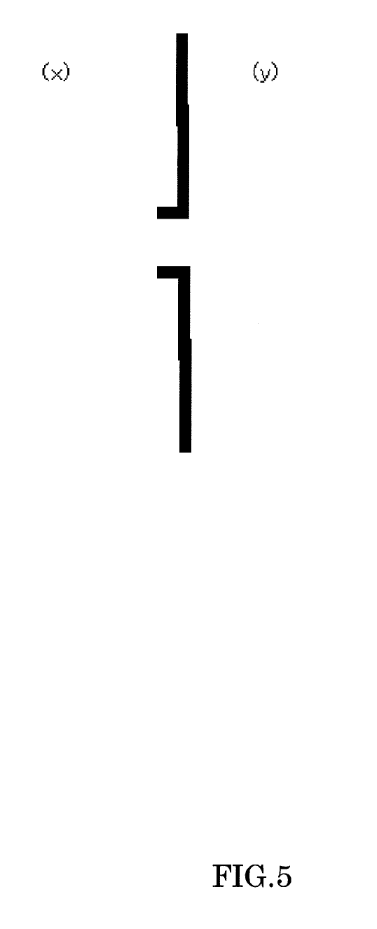

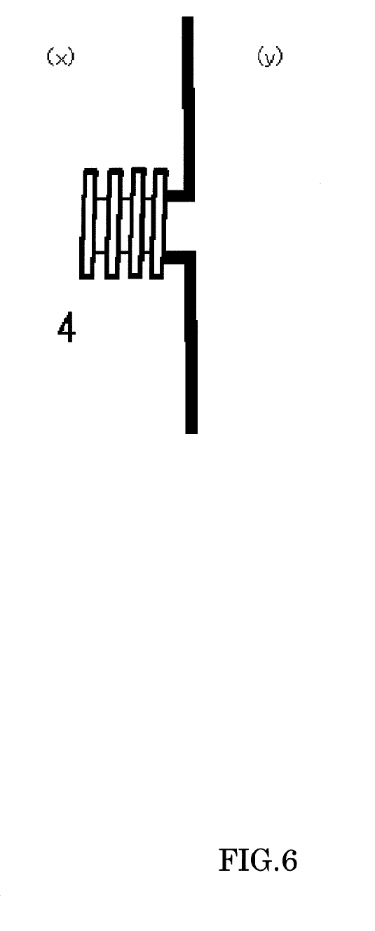

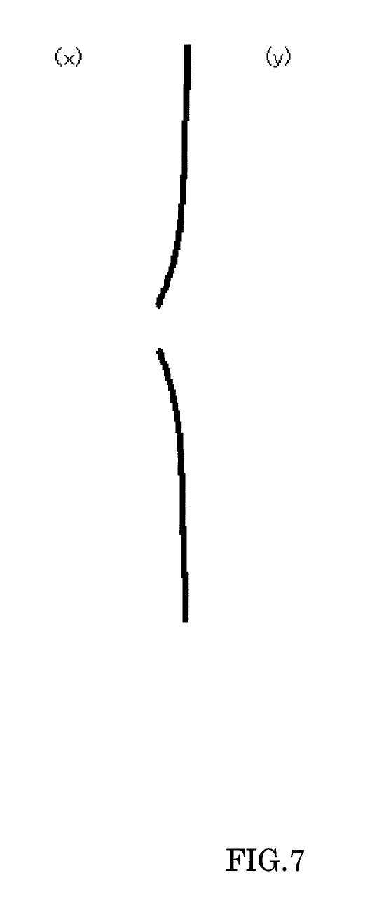

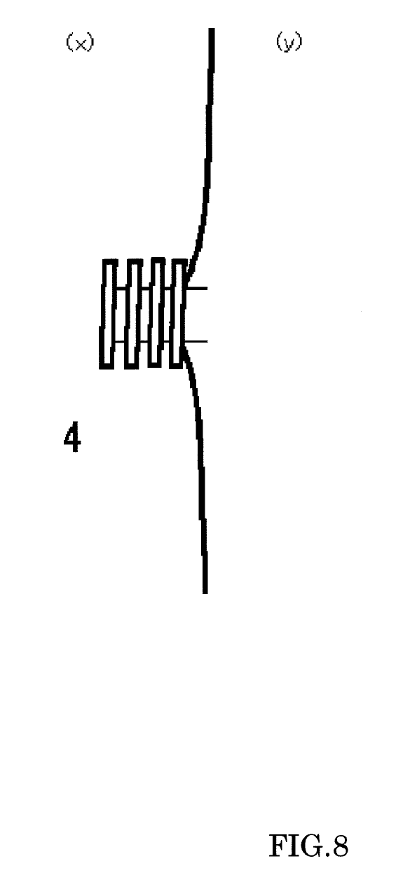

With regard to an ordinary lightweight steel frame conforming to the JIS, piercing a 2.3 mm steel sheet with an ordinary reamer screw from an external direction (y) causes the reamer 6 to be stripped and leaves a perpendicular burr on the side of an internal direction (x) of the lightweight steel frame (see FIG. 5). Thus, the threaded portion 5 with the screw thread 4 is reliably screwed (see FIG. 6). However, in the case of the U-shaped steel sheet 13, which is a lightweight thin steel sheet of about 1.2 mm, the reamer 6 is stronger than the U-shaped steel sheet 13 because the thickness of the steel sheet is small, and so the reamer 6 is not stripped. Thus, the threaded portion 5 rotates without making contact, which means that a clearance hole is formed in the steel sheet. To address this issue, in order to compensate for the weakness of the burr on the lightweight thin steel sheet, the diameter of the drill portion 9 that is tapered in order to increase its thickness is reduced so that the burr can protrude. At this time, the protruding burr has a curved surface shape as shown in FIG. 7, and the threaded portion 5 with the screw thread 4 reliably engages and is screwed (see FIG. 8).

When the fixing member 1 having the above-described configuration is used, the ceramic exterior building material 11 is fixed to the U-shaped steel sheet 13 in the following manner (see FIGS. 2, 3, and 4). First, the ceramic exterior building material 11 is placed on the surface of the U-shaped steel sheet 13 that is fixed to the exterior side of the structural skeleton 14 via the L-shaped steel sheet 12 and that is slide adjustable. In this state, the fixing member 1 is screwed into the surface of the ceramic exterior building material 11 by fitting a tool such as a driver bit into the fitting recess 10 of the fixing member 1 and operating this tool. Thus, the fixing member 1 advances until the pilot portion 8 goes into the exterior building material with the tapered drill portion 9 rotating. At this time, the thickness of the ceramic exterior building material 11 is 8 mm, the combined length of the tapered drill portion 9 and the pilot portion 8 is about 10 mm, the following reamer 6 presses the ceramic exterior building material 11 down while cutting the exterior building material, and the screw thread 4 does not yet reach the ceramic exterior building material 11. Therefore, the ceramic exterior building material 11 is not lifted (see FIG. 2).

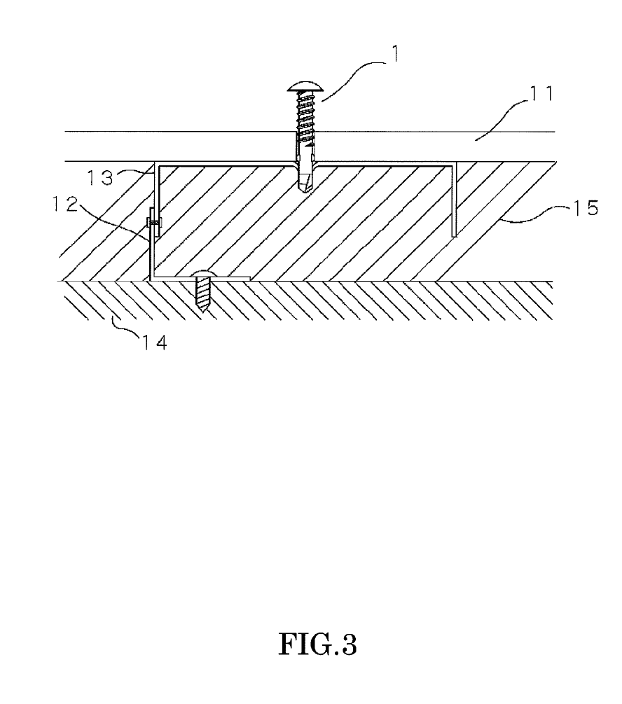

Next, the cutting portion 7 with the reamer 6 also moves downward while rotating (see FIG. 3). At this time, since the outer diameter “b” of the cutting portion 7 is larger than the outer diameter “c” of the threaded portion 5 with the screw thread 4, vibrations are unlikely to be transmitted to the ceramic exterior building material 11, and therefore floating of the ceramic exterior building material 11 can be reliably prevented during installation. Next, the reamer 6 of the cutting portion 7 comes into contact with the lightweight thin steel sheet having a thickness of 1.2 mm, and the reamer 6 is stripped. Thus, the threaded portion 5 with the screw thread 4 of the screw portion 2 fits in the lightweight thin steel sheet. Since the reamer 6 is set to a thin, disk-like shape, and the burr protrudes to have a curved surface shape, the threaded portion 5 with the screw thread 4 reliably engages and is screwed as shown in FIG. 3. Since the reamer 6 is stripped, no clearance hole is formed in the lightweight thin steel sheet. Next, the head portion 3 uniformly presses against the surface of the ceramic exterior building material 11, and thus the exterior building material reliably comes into contact with the U-shaped steel sheet 13 (see FIG. 4).

The pilot portion 8 that is not provided with the screw thread 4 and has a length “e” of 5 mm and the tapered drill portion 9 having a length “f” of 5 mm, which amount to a total length of 10 mm, pass through the base, and, meanwhile, the reamer 6 having the outer size “b” creates a hole while pressing the ceramic exterior building material 11 down. At that time, the screw thread 4 having the diameter “c” does not come into contact with the ceramic exterior building material 11, and therefore cracking or fracture of the ceramic exterior building material 11 due to floating does not occur. Thus, it is not necessary to strongly press down and hold the ceramic exterior building material 11 during installation, so that the safety and the effect of making the installation easy are provided.

The tapered drill portion 9 has a tapered shape having the outer diameter “d” of about 2.3 mm, and therefore easily penetrates the 1.2 mm lightweight thin steel sheet and causes the lightweight thin steel sheet to protrude into a curved surface shape, so that the screw thread 4 of the threaded portion 5 easily engages and is screwed (see FIGS. 7 and 8). Thus, no clearance hole is formed, and the threaded portion 5 can be fixed. Next, the pilot portion 8 having a smooth surface weakens the resistance with respect to a metal such as the lightweight thin steel sheet. Rotation of the cutting portion 7 with the reamer 6 weakens the frictional resistance of the ceramic exterior building material 11, reduces the occurrence of cracking or fracture, and can eliminate floating of the ceramic exterior building material 11 during installation. Finally, the flat surface of the head portion 3 can cause the screw pressure to be uniformly applied to the ceramic exterior building material 11 during fastening of the exterior building material.

Therefore, the use of the fixing member 1 for the ceramic exterior building material 11 of 14 mm or less according to the present invention even makes it possible to fasten the exterior building material with screws to a lightweight thin steel sheet having a thickness of 1.2 mm, such as the U-shaped steel sheet 13, which has conventionally been an undesirable installation method.

What is claimed is:

1. A fixing member for fixing a ceramic exterior building material to a lightweight thin steel sheet, the fixing member comprising:
a screw portion; and
a head portion at an upper end of the screw portion,
wherein a threaded portion in which a screw thread is formed is provided at a lower end of the head portion, a cutting portion in which a reamer is formed is provided at a lower end of the threaded portion, a pilot portion that has no screw thread is provided at a lower end of the cutting portion, and a tapered drill portion is provided at a lower end of the pilot portion, and
a thickness “g” of the ceramic exterior building material and a total of a length “e” of the pilot portion that has no screw thread and a length “f” of the tapered drill portion satisfy a relationship g<e+f.

2. The fixing member according to claim 1, wherein an outer diameter of the tapered drill portion is smaller than an outer diameter of the threaded portion in which the screw thread is formed.

3. The fixing member according to claim 1 or 2, wherein an outer diameter “a” of the head portion, an outer diameter “b” of the cutting portion, an outer diameter “c” of the threaded portion in which the screw thread is formed, and an outer diameter “d” of the tapered drill portion satisfy a relationship a>b>c>d.
